(19) United States
(12) Patent Application Publication
(10) Pub. No.: US 2018/0238086 A1
(43) Pub. Date: Aug. 23, 2018

(54) INCREMENTAL WINDOW OR DOOR ASSEMBLY

(71) Applicant: Patrick Aaron MORRIS, Omaha, NE (US)

(72) Inventor: Patrick Aaron MORRIS, Omaha, NE (US)

(21) Appl. No.: 15/657,879

(22) Filed: Jul. 24, 2017

Related U.S. Application Data
(60) Provisional application No. 62/461,921, filed on Feb. 22, 2017.

(51) Int. Cl. E05C 9/04; E05B 65/08; E05C 9/18; E05D 15/16

(52) U.S. Cl. CPC E05C 9/042; E05B 65/087; E05Y 2900/148; E05D 15/165; E05C 9/1808

(57) ABSTRACT

An assembly that allows for incremental displacement of a window or door sash relative to a frame. Such a window or door system may include a handle exposed outside the window or door, retractable pins located on a sash of the window or door and holes on jambs of the window or door. The pins may be inserted into the holes to prevent the window or door from being moved if the handle is not turned. Turning the handle may pull the pins out of the holes and allow the window or door to move. A spring or similar mechanism may cause the pins to return the pins' protruding state when the handle is not being turned. The user may open the window or door to a desired open position by turning the handle and may lock the window or door at the opened position by releasing the handle for the pins to be inserted into corresponding holes for locking.

### BACKGROUND

Generally, balance assemblies of a hung window enable a user to position a window sash at a desired opened position. According to the structure of the balance assembly which is well known in the art, balances are located in jambs (vertical side posts of a window frame) and the balances hold the weight of the window sash up so that the window does not to fall when the user opens it. Particularly, pivot bars, which are usually small metal bars, are attached to the bottom of the window sash. The pivot bars stick out of the window sash to be connected to balance shoes. The balance shoes are usually small plastic or metal blocks and inside the balances. The balance shoes connect the balances in the jambs to the pivot bars attached in the window sash.

This type of balance assembly can be broken by various factors. First, the pivot bars can be broken, twisted, or otherwise not engage with the balance shoes. Also, the balance shoes can be cracked, become stuck or otherwise be defective, causing improper operation. Further, because the balances hold the window sash under specific tension, the balance is vulnerable to external impacts as well, and may be loosened as time goes by.

### SUMMARY OF THE INVENTION

An assembly for incremental displacement of a window or door sash relative to a frame may be provided. According to an exemplary embodiment, the assembly may include a pair of substantially parallel tracks mounted along opposing vertical jambs of the frame. Each track may consist of an elongated body having a plurality of holes formed therethrough. A pair of retractable pins, extending within an interior cavity of the sash, may be configured to releasably engage at least one of the plurality of holes provided by the tracks. A rotatable handle may be operatively coupled to the pair of retractable pins, such that rotation of the handle causes translational movement of the retractable pins. The rotatable handle may be mounted to an exterior surface of the sash and moveable between a locked and an unlocked position. Turning the handle in a counter-clockwise direction, for example, may withdraw the pins from engagement with the holes, thereby unlocking the sash to slide freely in the frame. A user may then adjust the positioning of the sash to a desired location relative to the frame before releasing the handle back to its locked configuration. The retractable pins may securely engage holes corresponding to the location of adjustment.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 may illustrate an exemplary embodiment of an assembly for incremental displacement of a sash relative to a frame.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

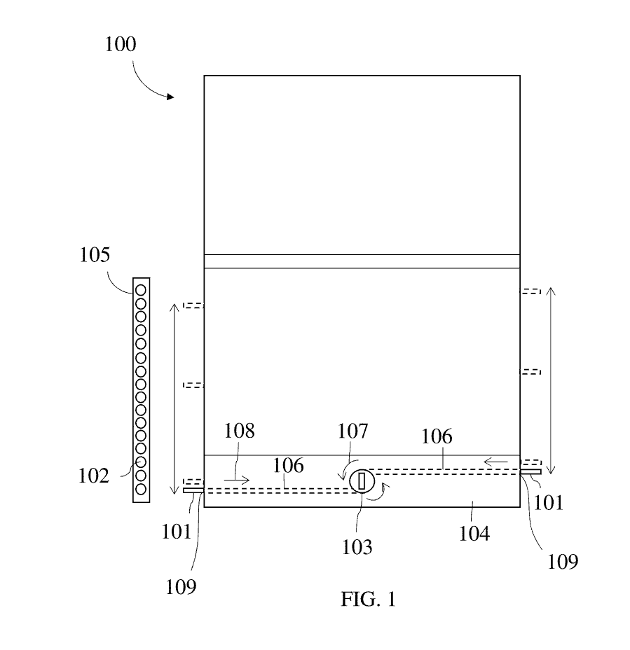

FIG. 1 may illustrate an exemplary embodiment of an assembly for incremental displacement of a window or door sash relative to a frame. The assembly may be compatible with a conventional hung window, including but not limited to a double hung window, a single hung window, a slider window, and the like. As shown in exemplary FIG. 1, the assembly is applied to a vertical sliding hung window. The assembly described herein may operate to releasably secure the sash within the frame, thereby facilitating the opening and closing operations of the sash along its predefined trajectory.

Referring to FIG. 1, the assembly is shown for integration with a rectangular outer frame securable to an aperture in a building wall (not shown). The frame may include a generally conventional lower window sash, defining a vertically moveable window unit within the frame. The frame may further include a pair of parallel vertically extending jambs rigidly interconnected by a horizontally extending head member and a horizontally extending sill member. The lower window sash may be slidable within the frame between a fully open position and a fully closed position.

The basic principle of the incremental window assembly 100 is that the window is locked at its sliding track 105 by inserting pins 101 of the window into holes 102 of the sliding track 105. In particular, the incremental window 100 includes the pins 101, the holes 102, and a handle 103. The handle 103 is exposed outside the window and used to lock or unlock the window. The handle 103 has round operating mechanisms and the mechanisms are configured inside the window sash 104. For example, the handle 103 has a bolt or spindle running with the handle 103 and the spindle is connected to rods 106 inside the window sash 104. Turning the handle 103 pulls the rods 106 in the direction of the turn. In particular, the rods 106 may be pulled almost in a tangent direction of a circle, where the circle is defined by the vertical section of the spindle. At the end of the rods 106, the pins 101 are connected. The pins 101 are retractably incorporated on the vertical side of the window sash 104. Here, the rotatory movement 107 of the handle 103 is to be converted to the rectilinear movement 108 of the rods 106 and the pins 101. Thus, in the exemplary embodiment, the connection types between the spindle of the handle 103 and the rods 106, and between the rods 106 and the pins 101 may be a type of joint which allows a flexible movement, such as a knuckle joint, a ball joint, a spherical rolling joint, and the like.

In the exemplary embodiment, the pins 101 are in a protruding state out of the vertical side of the window sash 104 if the handle 103 is not turned. Then, if the handle 103 is turned, the pins 101 are retracted into the window sash 104. A spring or similar mechanism inside the window sash 104 may cause the pins 101 to return the pins' protruding state when the handle 103 is not being turned. Such a spring mechanism may be very simple and is well known in the art. For example, a coil spring may be attached to the bolt or spindle of the handle 103.

On vertical sliding tracks 105, which are on jambs of the window frame, holes 102 are arranged in a line with a predetermined distance between each pair of two holes 102 for the pin 101 to be inserted into one of the holes 102. In the exemplary embodiment, the holes 102 can be arranged from end to end of the jambs with increments of the predetermined distance, so that the pin 101 may be inserted into the one of the holes 102 which is on a desired open position or a closed position (the end of the jamb). The pins 101 and the sliding tracks 105 which have the holes 102 can be formed out of any desired material, for example steel or other materials having desired strength to sustain the weight of the window sash 104. The holes 102 can be punched into, for example, with ⅛ inch thick and the pins 102 can have a thick which is proper to be inserted into the holes 102 and to lock the desired open position.

The handle 103 can be fabricated, for example, at the upper, middle, down, or any desired height of the sash 104 depending on different security needs.

In operation, the pins 101 are inserted into the holes 102, which are punched or carved out of the sliding track 105 and which prevent the window from being moved if the handle 103 is not turned. As explained above, a spring or similar mechanism inside the sash 104 may cause the pins 101 to return the pins' protruding state (inserted in the holes 102) when the handle 103 is not being turned. Turning the handle 103 may pull the pins 101 out of the holes 102 and allow the window to move. The user may open the window to a desired open position by turning the handle 103 and may lock the window at the desired open position or the closed position by releasing handle 103 for the pins 101 to be inserted into corresponding holes 102.

The incremental window 100 described herein does not need tension, unlike the conventional balance assembly of the hung window, so operational capabilities may not be degraded over time and components may have a slower wear rate. Also, exemplary embodiments may be less vulnerable to external impacts than the prior art. In the incremental window 100, the insertion of the pins 101 into the holes 102 may further function as a locking mechanism, so the incremental window 100 does not need locks on a middle sash 104, unlike the known or conventional hung window which has the balance assembly.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

1. An assembly for incremental displacement of a window or door sash relative to a frame, said assembly comprising:
a pair of substantially parallel tracks mounted along opposing jambs of the frame, each track having a plurality of holes formed therethrough;
a pair of retractable pins extending within the window or door sash and each pin configured to extend and removeably engage with respective one of the plurality of holes and retract and removeably disengage from respective one of the plurality of holes;
a pair of rods, each rod having an elongate body with an end coupled to a respective one of the pair of retractable pins by a joint; and
a handle rotatably mounted to an exterior surface of the window or door sash and movable between a locked position and an unlocked position, the handle operatively coupled to the pair of retractable pins, wherein rotation of the handle causes translational movement of the rods and the retractable pins,
wherein each pin extends through and out from a vertical side of each respective track when engaged with respective one of the plurality of holes.

2. The assembly of claim 1, wherein the retractable pins are operable between an extended position, a retracted position, and any position therebetween.

3. The assembly of claim 2, wherein the handle operatively moves the retractable pins from the extended position to the retracted position as the handle moves from the locked position towards the unlocked position.

4.-7. (canceled)

8. The assembly of claim 1, wherein each rod is configured to translationally move in a corresponding linear direction relative to a rotational direction of the handle when the handle is rotated.

9.-12. (canceled)

13. The assembly of claim 1, wherein the plurality of holes are arranged in a line with a predetermined distance between each hole.

14. The assembly of claim 1, wherein the plurality of holes extend an entire length of each track.

15. The assembly of claim 1, wherein the plurality of holes are each ⅛ of an inch deep.
